(19) United States
(12) Patent Application Publication
(10) Pub. No.: US 2025/0375647 A1
(43) Pub. Date: Dec. 11, 2025

(54) MAKING ELEMENTAL MERCURY AMENABLE TO UNDERGROUND INJECTION

(71) Applicant: VLS Environmental Solutions, LLC, Houston, TX (US)

(72) Inventors: Walter R. Stringer, Pasadena, TX (US); Christopher J. Lobue, New Waverly, TX (US); Robert A. Michael, Houston, TX (US); Gilbert D. Valdez, Houston, TX (US)

(73) Assignee: VLS Environmental Solutions, LLC, Houston, TX (US)

(21) Appl. No.: 19/054,273

(22) Filed: Feb. 14, 2025

Related U.S. Application Data
(60) Provisional application No. 63/657,392, filed on Jun. 7, 2024.

(51) Int. Cl. A62D 3/36; A62D 101/43; E21B 41/00

(52) U.S. Cl. CPC A62D 3/36; E21B 41/0057; A62D 2101/43

(57) ABSTRACT

A method may include pumping a mercury solution into a disposal well. A system may include a source of aqueous mercury solution, a pump, and a wellhead, wherein the source of aqueous mercury solution is fluidically coupled to the pump and the pump is fluidically coupled to the wellhead.

### CROSS REFERENCE TO RELATED APPLICATIONS

This application claims the priority of U.S. Provisional Patent Application No. 63/657,392, filed Jun. 7, 2024, which is incorporated by reference in its entirety.

### BACKGROUND

Elemental mercury and mercury compounds (collectively referred to as mercury herein) are utilized in various industries including chemical product manufacturing, institutional lighting manufacturing, dental supplies and manufacturing, display manufacturing such as computer monitors and plasma televisions, manufacture of printed circuit boards, as well as in manufacture of switches, relays, sensors, and valves, and in manufacturing batteries such as electric and hybrid vehicle batteries. Mercury is also utilized in vaccine manufacture as a preservative and as a reagent, catalyst, buffer, and fixative in certain formulated products. Mercury is also encountered as a byproduct of refining certain ores such as gold and in the production of oil and gas.

Mercury does not degrade, cannot be destroyed, and is a persistent and bio accumulative toxicant. Emitted elemental mercury can be transported in the atmosphere on local, regional, and global scales as it cycles through air, land, and water. Some of the emitted elemental mercury following deposition and transformation into divalent mercury can be bio transformed into methylmercury. Methylmercury can bioaccumulate and bio magnify in fish, and can be consumed by humans, as well as marine mammals. As such, mercury-bearing wastes constitute a major environmental risk and mercury wastes much be carefully handled to avoid volatilization and leaching into aqueous media.

In other countries, mercury-bearing waste may be processed to stabilize the mercury into a more stable form which can then be disposed of according to local regulations. For example, mercury waste may be amalgamated with sulfur to form HgS in a process referred to as stabilization and solidification. The amalgamation product is then permanently stored at a disposal site such as in a suitable vessel located in above ground storage facilities. However, this method is prohibited by the United States Environmental Protection Agency (EPA). Additionally, such storage facilities present challenges as the storage facilities require regular monitoring for mercury contamination of the surrounding areas as well as extensive resources such as land and construction costs, utilities, transportation, and labor force to ensure the safety and stability of the storage facilities. While such storage facilities may be classified as permanent storage, there exist risks of mercury contamination with aboveground storage as the facilities must be monitored and maintained. Furthermore, there exist significant drawbacks to storing HgS including that HgS is subject to leaching. Thus, every permanent above ground storage solution must have a constant capital input to monitor for leaching and remediate any leached product.

### BRIEF DESCRIPTION OF THE DRAWINGS

These drawings illustrate certain aspects of some of the embodiments of the present invention and should not be used to limit or define the invention.

FIG. 1 illustrates a block flow diagram of a method for disposing of mercury-bearing waste in accordance with embodiments of the present disclosure.

FIG. 2 illustrates an injection well disposal facility for disposing of mercury-bearing waste in accordance with embodiments of the present disclosure.

FIG. 3 is a graph of experimental results showing time versus reaction temperature in accordance with embodiments of the present disclosure.

FIG. 4 is a graph of experimental results showing time versus reaction temperature in accordance with embodiments of the present disclosure.

### DETAILED DESCRIPTION

Disclosed herein are methods of disposing mercury-bearing waste and, more particularly, disclosed are methods of forming a mercury solution and injecting the mercury solution into an underground disposal well. The underground disposal well includes a wellhead at the surface which is fluidically connected to a wellbore penetrating a subterranean formation. The wellhead allows for controlled injection of the mercury solution into the subterranean formation through the wellbore and prevents the mercury solution from being re-produced from the subterranean formation once injected. In some embodiments, the disposal well may be located in a subterranean formation comprising a substantially impermeable upper confining zone which prevents the injected mercury solution from migrating into other strata of the subterranean formation. In some embodiments, the disposal well may be located in a subterranean formation which is substantially sealed from fluid communication with underground water sources. In some embodiments, the disposal well may be located in a section of subterranean formation which does not have fluid communication with other wells such as producer wells such that once injected, the mercury solution should be substantially sealed in place within the subterranean formation. In some embodiments, the disposal well can be purpose built for the injection of mercury solution. In some embodiments, the disposal well includes a disposal well classified as a Class I Industrial and Municipal Waste Disposal Well as defined by the EPA.

The present disclosure has several advantages over previous methods of disposal of mercury-bearing wastes. As discussed above, the above ground storage methods have several drawbacks including risks of contamination to the area where the mercury-bearing waste is stored as well as ongoing capital maintenance of the above ground storage facilities. One advantage of storing mercury solution in underground disposal wells is that the volume of mercury-bearing waste that can be stored at a location is many times greater than in an above ground storage facility in accordance with example embodiments. The footprint and land requirements of an underground disposal well to store a volume of mercury solution is smaller than the equivalent above ground storage facility for stabilized mercury in accordance with example embodiments. Another advantage of disposing mercury-bearing waste in an underground disposal well is that the underground storage well has a lower utility demand and maintenance cost as compared to above ground storage in accordance with example embodiments. An underground disposal well only requires power when the mercury solution is injected into the disposal well, for example, whereas an above ground storage facility typically requires constant power for lighting, air conditioning, and other associated facilities operation. In accordance with example embodiments, an underground storage well does not have the risks of facilities damage due to weather or other natural disasters. Furthermore, when an underground disposal well is ready to be abandoned, in some embodiments, a plug and abandon operation can be performed whereby the wellbore is filled with a cement to permanently shut-in the wellbore thereby preventing the injected mercury solution from being produced from the disposal well. An underground disposal well may be a long-term solution for mercury-bearing wastes where the mercury solution can be safely stored for hundreds of years. By way of further example, the methods disclosed herein have further advantages as the mercury is removed from the biosphere.

The mercury-bearing waste or mercury-containing compound suitable for use in the present methods may be from any source and may include any form of mercury, including elemental mercury Hg⁰, inorganic mercury compounds including, mercury (i) arsenate, mercury (ii) arsenate, mercury (i) bromide, mercury (ii) bromide, mercury (i) chloride, mercury (ii) chloride, mercury (i) fluoride, mercury (ii) fluoride, mercury (i) iodide, mercury (ii) iodide, mercury (i) nitrate, mercury (ii) nitrate, mercury (i) oxide, mercury (ii) oxide, mercury (i) sulfate, mercury (ii) sulfate, mercury (ii) sulfide, mercury (ii) amidochloride, organomercury compounds including, diethyl mercury, dimethyl mercury, diphenyl mercury, ethyl mercury, mercury (i) acetate, mercury (ii) acetate, mercury stearate, methyl mercury, methyl mercury acetate, methyl mercury chloride, phenyl mercury acetate, phenyl mercury borate, phenyl mercury chloride, phenyl mercury nitrate, mercury amalgams including, dental amalgam, mercury-aluminum amalgam, mercury-gold amalgam, mercury-zinc amalgam, mercury minerals and ores including calomel, cinnabar, coloradoite, metacinnabar, tiemannite and mercury bearing byproducts of industrial processes including Boliden/Norzink process that yields calomel, and combinations thereof.

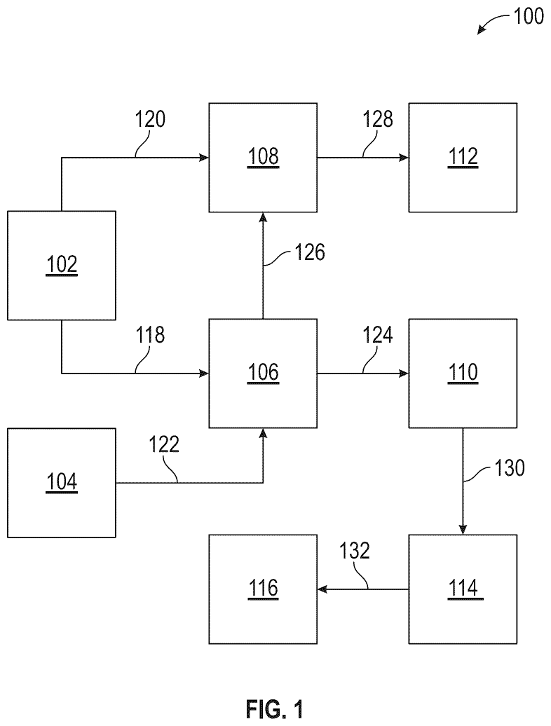

FIG. 1 is a block flow diagram of a method 100 for disposing of mercury-bearing waste in accordance with embodiments of the present disclosure. In block 102 the mercury-bearing waste is collected and categorized according to the waste type. As will be discussed later, the specific processing steps for handling each type of mercury-bearing waste may depend on the chemical identity of the mercury-bearing waste. In embodiments, mercury-bearing waste can be stored in suitable containers such as drums, mercury flasks, 1-metric ton mercury containers, and the like in block 102.

From block 102, mercury-bearing waste is introduced via line 118 to block 106 where the mercury-bearing waste from block 102 is reacted to form a solution of mercury. In embodiments, mercury-bearing waste can undergo many different reactions to form a soluble form of mercury, the specific reactions which depend on the chemical identity of the mercury-bearing waste. For example, mercury (II) chloride (HgCl₂) does not need to be made soluble as mercury (II) chloride (HgCl₂) is substantially soluble in water. Alternatively, elemental mercury is insoluble in water and would need to be reacted with a chemical component to make the elemental mercury water soluble. In embodiments, elemental mercury is reacted with an acid to form an aqueous solution of mercury. As shown in FIG. 1, in block 104 acid is stored and provided to block 106 via line 122.

In some embodiments in block 106, elemental mercury is reacted with a mineral acid such as hydrochloric acid (HCl), nitric acid (HNO₃), phosphoric acid (H₃PO₄), sulfuric acid (H₂SO₄), boric acid (H₃BO₃), hydrofluoric acid (HF), hydrobromic acid (HBr), perchloric acid (HClO₄), hydroiodic acid (HI), or a combination thereof. The result of the reactions is to produce an aqueous mercury solution. In further embodiments, the mercury-bearing waste is reacted in an alternative solvent such as ethanol or carbon tetrachloride to produce a corresponding solution of mercury.

The acid and mercury-bearing waste may be mixed in block 106 by any suitable reaction vessel such as in a continuously stirred stank reactor (CSTR), a batch mixer such as a ribbon blender or paddle mixer, in an inline mixer including a static mixer or dynamic mixer, a planetary mixer, a roto-stator mixer, a homogenizer, a jet mixer, a tank having a pump around loop, or a combination thereof. In embodiments, the reaction vessel is configured with inlets for acid and mercury-bearing waste and a mixing means for mixing the acid and mercury-bearing waste. The reaction vessel may be suitable to contain the acid and mercury-bearing waste during the reaction phase. In embodiments, the mixer further includes an outlet for withdrawing the mercury product solution from the reaction vessel and optionally an outlet for withdrawing gaseous products which evolve during the reaction phase.

As shown in FIG. 1., gaseous products are withdrawn from block 106 and introduced into block 108 via line 126 and, additionally, mercury vapors and other mercury-containing gasses may be sequestered in block 102 and introduced into block 108 via line 120. In block 108, the collected gasses are introduced into a mercury scrubber to remove mercury from the gasses. In embodiments, the mercury scrubber includes a suitable scrubber for removing mercury such as an activated carbon injection scrubber, a fixed bed absorber, a sorbent enhanced fabric filter absorber, or in a wet scrubber where the gasses are passed through a liquid solution where the mercury is either absorbed or reacted with the liquid solution to remove the mercury from the gasses. In embodiments, a wet scrubber includes a chlorine or bromine compound solution which oxidizes elemental mercury (Hg⁰) to ionic forms such as (Hg²⁺) which are more soluble. In further embodiments, a wet scrubber includes sodium hypochlorite or hydrogen peroxide which form mercury compounds which remain in the liquid phase.

From block 108, gaseous products, such as NOx, are withdrawn via line 128 and introduced into block 112. In block 112, the gaseous products are treated in a NOx scrubber to remove NOx from the gaseous products. The NOx scrubber can include any suitable scrubber such as one which utilizes wet scrubbing via oxidation with bleach for example, and/or chemical absorption in sodium hydroxide and/or calcium hydroxide.

The acid may be added in any suitable amount to react the mercury-bearing waste with the acid to form the aqueous solution of mercury, or in embodiments, where another solvent is utilized, to form a solution of mercury in the solvent. In some embodiments, the acid is mixed with the mercury-bearing waste in a stoichiometric amount or greater to ensure all of the mercury-bearing waste is solubilized. In some embodiments, the acid is provided in an amount at a point in a range of 1 stoichiometric equivalent to 3 stoichiometric equivalent. Alternatively, the acid is provided in an amount at a point in a range of 1 stoichiometric equivalent to 1.5 stoichiometric equivalent, in an amount of 1.5 stoichiometric equivalent to 2 stoichiometric equivalent, in an amount of 2 stoichiometric equivalent to 3 stoichiometric equivalent, or any ranges therebetween.

In embodiments, the acid and mercury-bearing waste are continuously or intermittently mixed during the reaction phase. Alternatively, the acid and mercury-bearing waste are mixed for an initial period and thereafter allowed to remain in quiescent storage during the reaction phase. In embodiments, a reaction vessel includes a closed-loop recirculation system with bottom withdrawal and top return. The reaction vessel may include a pump which withdraws fluid from the bottom section of the reaction vessel and pumps the fluid through a conduit to the top portion of the reaction vessel.

In embodiments, the acid and mercury-bearing waste are allowed to react for any suitable amount of time to allow at least about 95 wt. % or greater of the mercury in the mercury-bearing waste to react with the acid. Alternatively, the acid and mercury-bearing waste are allowed to react for any suitable amount of time to allow at substantially all (e.g. greater than 99.9 wt. %) of the mercury to be reacted with the acid. In embodiments, the acid and mercury-bearing waste are reacted for a period of time at a point in a range of 10 minutes to 2 hours. Alternatively, the acid and mercury-bearing waste are reacted for a period of time at a point in a range of 10 minutes to 30 minutes, 30 minutes to 1 hour, 1 hour to 2 hours, or any ranges therebetween.

In some embodiments, the acid and mercury-bearing waste are reacted at elevated temperatures such as a temperature at a point in a range of about 10° C. to about 50° C. Alternatively, the acid and mercury-bearing waste are reacted at elevated temperatures such as a temperature at a point in a range of about 10° C. to about 50° C.

After the reaction phase is completed, the mercury product solution includes the mercury from the mercury-bearing waste in a solvated form as mercury ions or soluble mercury complexes. The mercury product solution may further include excess acid as well as any unreacted chemical compounds present in the mercury-bearing waste.

In embodiments, the reaction mixture may produce reaction products which can increase the reaction rate by autocatalyzing the reactions between the acid and mercury-bearing waste. Without being limited by theory, it is believed that the reaction products may exist in an elevated oxidation state or may include complexes which when mixed with an additional volume of acid and mercury-bearing waste, increase the reaction rate between acid and mercury-bearing waste. Thus, it has been discovered that leaving a portion or “heel” of reaction products in the reaction vessel and thereafter adding a volume of acid and mercury-bearing waste results in a decrease in the time required to complete the reaction between additional volume of acid and mercury-bearing. The decrease in reaction time allows for greater amounts of mercury-bearing waste to be processed per unit time thereby increasing the daily production capacity of the reaction vessel. In embodiments, after reaction, a portion of the mercury product solution is withdrawn leaving a portion of the mercury product solution in the reaction vessel. In some embodiments, 10 vol. % to 99 vol. % of mercury product solution is withdrawn from the reaction vessel after the reaction leaving 1 vol. % to 90 vol. % of the mercury product solution in the reaction vessel. Alternatively, 10 vol. % to 25 vol. % of mercury product solution is withdrawn from the reaction vessel after the reaction, 25 vol. % to 50 vol. % of mercury product solution is withdrawn from the reaction vessel after the reaction, 50 vol. % to 75 vol. % of mercury product solution is withdrawn from the reaction vessel after the reaction, 75 vol. % to 99 vol. % of mercury product solution is withdrawn from the reaction vessel after the reaction, or any ranges therebetween.

In embodiments, additional steps in block 106 include adjusting the physical properties of the mercury product solution such that the mercury product solution is amenable to underground injection. For example, the acid content of injected waste stream may be 30 wt. % or less as measured by AWWA Standard Methods 22nd Edition 2310 B. Additionally, specific gravity of injected fluids may be at a point in a range of 0.95 to 1.4 as measured according to ASTM Method D1429-13 Test Method C at 20° C.

In embodiments, the mercury product solution is adjusted with an aqueous solution such that the acidity of the mercury product solution is 30 wt. % acid or less. Alternatively, the mercury product solution is adjusted with an aqueous solution such that the acidity of the mercury product solution is 20 wt. % acid or less, 15 wt. % acid or less, 10 wt. % acid or less, or 5 wt. % acid or less as measured by AWWA Standard Methods 22nd Edition 2310 B.

In further embodiments, the aqueous solution includes a basic compound, such as a Group I hydroxide and/or a Group II hydroxide, which reacts with the acid present in the mercury product solution such that the acidity of the mercury product solution is 30 wt. % acid or less. Alternatively, the mercury product solution is neutralized with an aqueous solution including a basic compound such that the acidity of the mercury product solution is 20 wt. % acid or less, 15 wt. % acid or less, 10 wt. % acid or less, or 5 wt. % acid or less as measured by AWWA Standard Methods 22nd Edition 2310 B.

In some embodiments, the aqueous solution is mixed with the mercury product solution in an amount to provide a mercury product solution with a specific gravity at a point in a range of 0.95 to 1.4 as measured according to ASTM Method D1429-13 Test Method C at 20° C. Alternatively, the mercury product solution is adjusted to have a specific gravity at a point in a range of 0.95 to 1.0, 1.0 to 1.2, 1.2 to 1.4, or any ranges therebetween as measured according to ASTM Method D1429-13 Test Method C at 20° C.

In further embodiments, the aqueous solution includes weighting agents such as salts, including, but not limited to, chloride (CaCl₂), potassium formate (KHCOO), cesium formate (CsCOOH), zinc bromide (ZnBr₂), sodium bromide (NaBr), calcium bromide (CaBr₂), or combinations thereof, such that when mixed the aqueous solution is mixed with the mercury product solution, the resultant mercury product solution has a specific gravity at a point in a range of 0.95 to 1.4 as measured according to ASTM Method D1429-13 Test Method C at 20° C. Alternatively, the mercury product solution is adjusted to have a specific gravity at a point in a range of 0.95 to 1.0, 1.0 to 1.2, 1.2 to 1.4, or any ranges therebetween. In some embodiments, the aqueous solution includes a saturated brine such as a brine which includes Group I and/or Group II elements and a corresponding halogen.

From block 106, method 100 proceeds to block 110 where mercury product solution is withdrawn using line 124 and introduced into block 110. In block 110 the mercury product solution is injected into an underground disposal well such as those wells which are classified as EPA Class I Industrial and Municipal Waste Disposal Well. In block 110, the mercury product solution may be stored for a period of time before injection into the disposal well. For example, the mercury product solution may be stored in tanks, totes, containers, or the like prior to injection into the disposal well. In embodiments, the mercury product solution is pressurized, such as by a pump, to an injection pressure and allowed to flow into an injection zone within the disposal well.

In embodiments, acid gases may evolve during the storage and/or pumping of the mercury product solution. The evolved gasses may be collected and/or otherwise sequestered and introduced into block 114 via line 130. In block 114, the evolved gasses are treated in an acid scrubber to neutralize the acid gasses. The acid scrubber can include any suitable scrubber such as one which utilizes wet scrubbing via chemical absorption in sodium hydroxide and/or calcium hydroxide or amine gas treating, for example. From block 114, the treated gaseous products may be introduced into block 116 via line 132 for thermal oxidation such as in a direct flame oxidation and/or catalytic oxidation. Alternatively, the treated gaseous products may be vented to atmosphere.

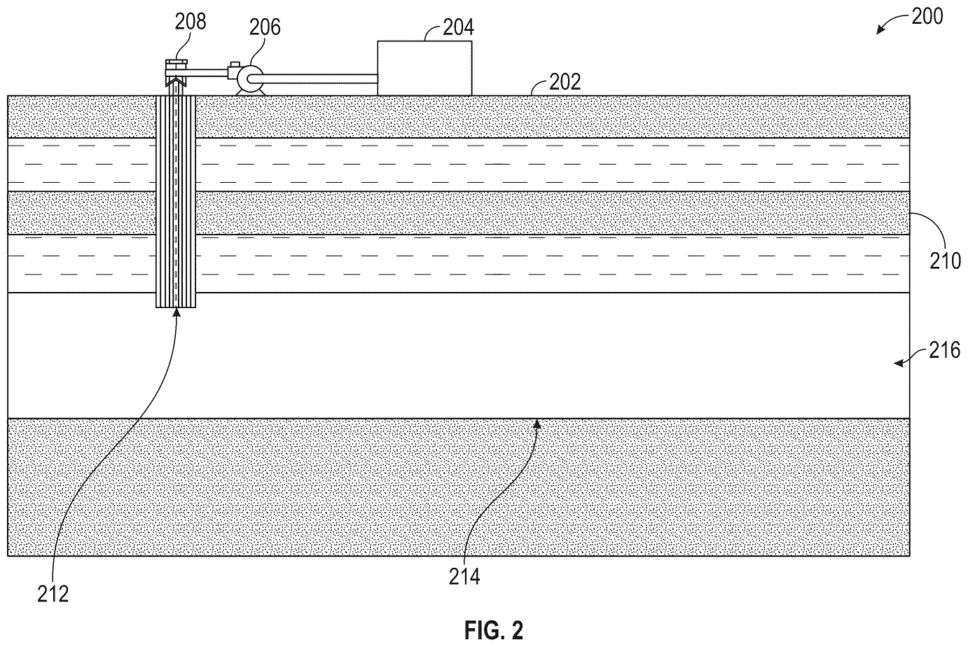

FIG. 2 illustrates an injection well disposal facility 200 located at a surface location 202 for injection of mercury product solution in accordance with certain embodiments. In some embodiments, the injection well disposal facility 200 includes an EPA Class I Industrial and Municipal Waste Disposal Well. As illustrated in FIG. 2, a mercury source 204 which contains the mercury product solution is fluidically connected to pump 206. The mercury source 204 can include the mercury product solution produced from method 100 in FIG. 1. The mercury product solution from mercury source 204 is pumped by pump 206 into wellhead 208 which is fluidically connected to wellbore 212 penetrating subterranean formation 214. Wellbore 212 allows for fluid communication between the wellhead 208 and injection zone 216. Pump 206 pumps the mercury product solution into injection zone 216. Subterranean formation 214 includes an upper confining zone 210 to prevent migration of injected mercury solution.

Accordingly, the present disclosure may relate to techniques for forming a mercury solution and injecting the mercury solution into an underground disposal well. The systems and methods may include any of the various features disclosed herein, including one or more of the following statements.
Statement 1. A method comprising: pumping a mercury product solution into a disposal well, wherein the disposal well is classified as a United States Environmental Protection Agency (EPA) Class I Industrial and Municipal Waste Disposal Well.
Statement 2. The method of statement 1 further comprising preparing the mercury product solution from elemental mercury and/or a mercury-containing compound.
Statement 3. The method of any of statements 1-2 wherein the mercury product solution has an acid content of about 30 wt. % or less as measured by AWWA Standard Methods 22nd Edition 2310 B.
Statement 4. The method of any of statements 1-3 wherein the mercury product solution has a specific gravity a point in a range of about 0.95 to about 1.4 as measured as measured according to ASTM Method D1429-13 Test Method C at 20° C.
Statement 5. The method of any of statements 1-4 further comprising: reacting an acid and the elemental mercury and/or mercury-containing compound to form the mercury product solution.
Statement 6. The method of any of statements 1-5 wherein the acid and the elemental mercury and/or mercury-containing compound are reacted until at least about 95 wt. % or greater of the mercury in the elemental mercury and/or mercury-containing compound is reacted with the acid.
Statement 7. The method of any of statements 1-6 further comprising mixing the mercury product solution with an aqueous solution after reacting with the acid.
Statement 8. The method of any of statements 1-7 wherein the mercury product solution is mixed with the aqueous solution in an amount such that the mercury product solution has an acid content of about 30 wt. % or less as measured by AWWA Standard Methods 22nd Edition 2310 B.
Statement 9. The method of any of statements 1-8 wherein the mercury product solution is mixed with the aqueous solution in an amount such that the mercury product solution has a specific gravity a point in a range of about 0.95 to about 1.4 as measured as measured according to ASTM Method D1429-13 Test Method C at 20° C.
Statement 10. The method of any of statements 1-9 wherein the aqueous solution comprises a Group I and/or a Group II hydroxide and wherein the aqueous solution is mixed with the mercury product solution in an amount to neutralize the mercury product solution to have an acid content of about 30 wt. % or less as measured by AWWA Standard Methods 22nd Edition 2310 B.
Statement 11. A method comprising: reacting an acid and elemental mercury and/or a mercury-containing compound in a reaction vessel to form a mercury product solution; withdrawing a first portion of the mercury product solution from the reaction vessel leaving a second portion of the mercury product solution in the reaction vessel; and introducing an additional volume of the acid and the elemental mercury and/or the mercury-containing compound into the reaction vessel and reacting the additional volume of the acid and the elemental mercury and/or the mercury-containing compound in the presence of the second portion of the mercury product solution to produce an additional volume of the mercury product solution.
Statement 12. The method of statement 11 further comprising pumping the acid and elemental mercury and/or the mercury-containing compound from a bottom section of the reaction vessel through a conduit to a top portion of the reaction vessel while reacting the acid and elemental mercury and/or the mercury-containing compound in the reaction vessel.
Statement 13. The method of any of statements 11-12 wherein the first portion of the mercury product solution comprises about 10 vol. % to about 99 vol. % of the mercury product solution in the reaction vessel.
Statement 14. The method of any of statements 11-13 further comprising: mixing the first portion of the mercury product solution with an aqueous solution such that the mercury product solution has an acid content of about 30 wt. % or less as measured by AWWA Standard Methods 22nd Edition 2310 B and a specific gravity a point in a range of about 0.95 to about 1.4 as measured as measured according to ASTM Method D1429-13 Test Method C at 20° C.
Statement 15. The method of any of statements 11-14 wherein the aqueous solution comprises a Group I and/or a Group II hydroxide.
Statement 16. The method of any of statements 11-15 further comprising: pumping the first portion of the mercury product solution into a disposal well, wherein the disposal well is classified as a United States Environmental Protection Agency (EPA) Class I Industrial and Municipal Waste Disposal Well.
Statement 17. A system comprising: a source of mercury product solution produced from elemental mercury and/or mercury-containing compounds; a pump; and a wellhead; wherein the source of mercury product solution is fluidically coupled to the pump and the pump is fluidically coupled to the wellhead.
Statement 18. The system of statement 17 wherein the wellhead is fluidically coupled to a disposal well classified as a United States Environmental Protection Agency (EPA) Class I Industrial and Municipal Waste Disposal Well.
Statement 19. The system of any of statements 17-18 wherein the wellhead is fluidically coupled to a disposal well and wherein the pump is configured to pump the mercury product solution into the disposal well.
Statement 20. The system of any of statements 17-19 wherein the mercury product solution has an acid content of about 30 wt. % or less as measured by AWWA Standard Methods 22nd Edition 2310 B and wherein the mercury product solution has a specific gravity a point in a range of about 0.95 to about 1.4 as measured as measured according to ASTM Method D1429-13 Test Method C at 20° C.

To facilitate a better understanding of the present invention, the following examples of certain aspects of some embodiments are given. In no way should the following examples be read to limit, or define, the entire scope of the disclosure.

### EXAMPLE 1

In this example, mercury salt was prepared. Some common inorganic water-soluble mercury salts include Mercury (II) Acetate and Mercury (II) Nitrate. Of the two, Mercury Nitrate is the most soluble in aqueous solutions.

First, 20% elemental mercury by weight was added to concentrated Nitric Acid (67%) solution at room temp. The solution was allowed to sit for 25-30 min for the elemental mercury to dissolve into solution to yield a 52.4% solution of concentrated nitric acid/mercury nitrate. The reaction was carried out under ventilation conditions to collect vapors generated during the process. Plant water was double filtered using a 5-micron filter and the concentrated nitric acid/mercury nitrate solution was adjusted approximately 18:1 to yield a 3% nitric acid solution.

A 11.4 g sample of the 52.4% concentrated nitric acid/mercury nitrate solution was added to a graduated cylinder and brine water was added to make up a 200 g total brine solution.

The resulting 3% nitric acid solution and brine solution were filtered at room temperature and it was observed that the solutions filtered well. The solutions were heated in a water bath and filtered again. It was observed that the heated solutions filtered well.

### EXAMPLE 2

In this example, three experimental configurations were utilized to prepare mercury solutions where the experimental configurations were designed to investigate reaction mechanisms, kinetics, and reaction optimization through systematic experimentation under varying conditions. This example utilized a pressure-capable glass reaction vessel equipped with temperature monitoring, mechanical stirring, and gas flow control systems. The experimental apparatus included inlet/outlet lines for purging and sampling, with downstream carbon beds specifically designed for capturing mercury vapor.

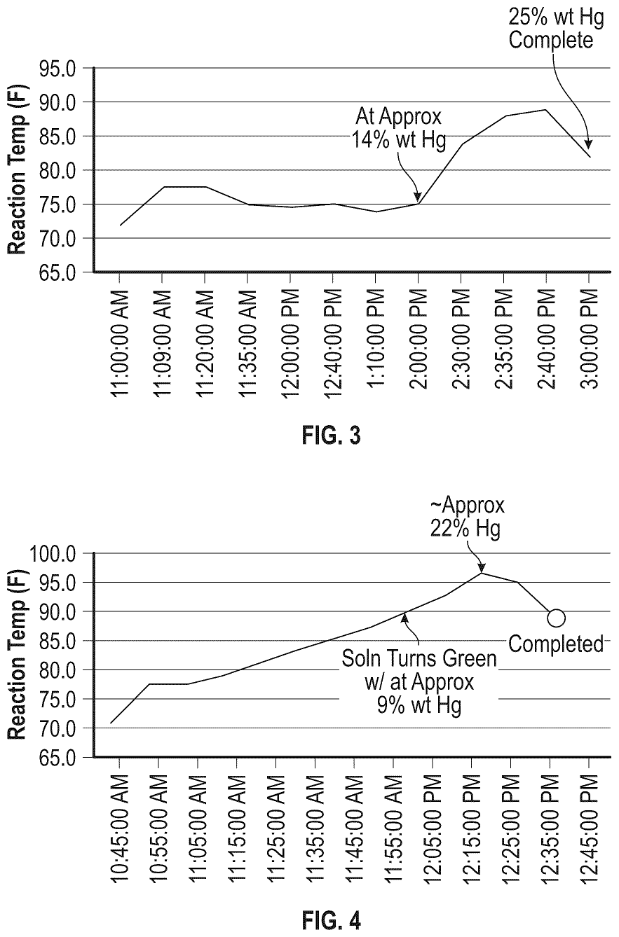

In the first experimental configuration, nitrogen was utilized as a purge gas flowing at 1.2 sL/min (standard liter per minute). Initially the reaction vessel was charged with 180 g of 70% HNO3 and 60 g of elemental mercury at ambient temperature. The reaction was allowed to proceed, and reaction measurements were taken intermittently. It was observed that the reaction temperature progressed from 72° F. to 89° F. over four hours, achieving approximately 25 wt. % mercury dissolution. It was observed that the reaction proceeded gradually with distinct color transitions from clear to orange and then orange to green. The time versus reaction temperature for the first experimental condition is shown in FIG. 3.

The second experimental configuration maintained identical reactant quantities (180 g of 70% HNO3 and 60 g of elemental mercury) but employed an air purge at the same flow rate of 1.2 sL/min instead of nitrogen. It was observed that this experimental arrangement exhibited enhanced reaction kinetics with a temperature increase from 71° F. to 96.2° F. The reactants demonstrated accelerated green coloration development and increased gas evolution with distinctive reddish-brown coloration, achieving completion in approximately half the time of the nitrogen-purged configuration. The time versus reaction temperature for the first experimental condition is shown in FIG. 4.

The third experimental configuration included three experiments with sequential addition of additional reactants. The initial run utilized the same quantities as previous configurations (180 g of 70% HNO3 and 60 g of elemental mercury), starting at 60° F. and generating 850 mL of deep orange gas over two hours.

For the second run, an additional charge of fresh reactants (180 g of 70% HNO3 and 60 g of elemental mercury) was added to the entire reaction mixture from the first run. This second run generated 820 mL of gas and demonstrated enhanced kinetics, completing in approximately one hour.

For the third run, half of the reaction mixture volume was removed, and fresh reactants (180 g of 70% HNO3 and 60 g of elemental mercury) were added to the remaining solution. This final run generated 800 mL of gas while maintaining green coloration throughout and achieved completion in approximately one hour.

Mechanistic analysis reveals a possible complex reaction pathway involving nitrous acid (HONO) as a crucial intermediate. Without being limited by theory, it is believe that the process begins with primary oxidation by the following reaction

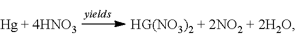

which is followed by catalyst generation by the following reaction:

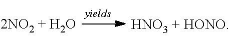

This cycle encompasses mercury oxidation by HONO, NOx generation, and catalyst regeneration, establishing a self-sustaining reaction system.

Detailed examination of the carbon beds in the reaction series experiment provided significant insights into gas handling dynamics. The primary bed (C1, 13.41 g) exhibited substantial orange gas evolution during routine weight analysis, while the secondary bed (C2, 15.24 g) showed minimal gas production. This differential absorption pattern demonstrated preferential NOx capture in the primary bed.

It was observed that there was a strong correlation emerged between green color development and reaction rate acceleration, suggesting the formation of possible specific mercury-nitrite complexes at elevated HONO concentrations. The enhanced reaction kinetics under air-purge conditions indicated a significant role for oxygen in the reaction mechanism, while the progressive reduction in reaction time during sequential additions further supported the proposed autocatalytic pathway.

It is to be understood that the present disclosure is not limited to particular methods, which may, of course, vary. It is also to be understood that the terminology used herein is for the purpose of describing particular embodiments only and is not intended to be limiting. All numbers and ranges disclosed herein may vary by some amount. Whenever a numerical range with a lower limit and an upper limit is disclosed, any number and any included range falling within the range are specifically disclosed. Although individual embodiments are discussed herein, the invention covers all combinations of all those embodiments. As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected. If there is any conflict in the usages of a word or term in this specification and one or more patent or other documents that may be incorporated herein by reference, the definitions that are consistent with this specification should be adopted for the purposes of understanding this invention.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

What is claimed is:

1. A method comprising:
pumping a mercury product solution into a disposal well, wherein the disposal well is classified as a United States Environmental Protection Agency (EPA) Class I Industrial and Municipal Waste Disposal Well.

2. The method of claim 1 further comprising preparing the mercury product solution from elemental mercury and/or a mercury-containing compound.

3. The method of claim 1 wherein the mercury product solution has an acid content of about 30 wt. % or less as measured by AWWA Standard Methods 22nd Edition 2310 B.

4. The method of claim 1 wherein the mercury product solution has a specific gravity a point in a range of about 0.95 to about 1.4 as measured as measured according to ASTM Method D1429-13 Test Method C at 20° C.

5. The method of claim 2 further comprising:
reacting an acid and the elemental mercury and/or mercury-containing compound to form the mercury product solution.

6. The method of claim 5 wherein the acid and the elemental mercury and/or mercury-containing compound are reacted until at least about 95 wt. % or greater of the mercury in the elemental mercury and/or mercury-containing compound is reacted with the acid.

7. The method of claim 5 further comprising mixing the mercury product solution with an aqueous solution after reacting with the acid.

8. The method of claim 7 wherein the mercury product solution is mixed with the aqueous solution in an amount such that the mercury product solution has an acid content of about 30 wt. % or less as measured by AWWA Standard Methods 22nd Edition 2310 B.

9. The method of claim 7 wherein the mercury product solution is mixed with the aqueous solution in an amount such that the mercury product solution has a specific gravity a point in a range of about 0.95 to about 1.4 as measured as measured according to ASTM Method D1429-13 Test Method C at 20° C.

10. The method of claim 7 wherein the aqueous solution comprises a Group I and/or a Group II hydroxide and wherein the aqueous solution is mixed with the mercury product solution in an amount to neutralize the mercury product solution to have an acid content of about 30 wt. % or less as measured by AWWA Standard Methods 22nd Edition 2310 B.

11. A method comprising:
reacting an acid and elemental mercury and/or a mercury-containing compound in a reaction vessel to form a mercury product solution;
withdrawing a first portion of the mercury product solution from the reaction vessel leaving a second portion of the mercury product solution in the reaction vessel; and
introducing an additional volume of the acid and the elemental mercury and/or the mercury-containing compound into the reaction vessel and reacting the additional volume of the acid and the elemental mercury and/or the mercury-containing compound in the presence of the second portion of the mercury product solution to produce an additional volume of the mercury product solution.

12. The method of claim 11 further comprising pumping the acid and elemental mercury and/or the mercury-containing compound from a bottom section of the reaction vessel through a conduit to a top portion of the reaction vessel while reacting the acid and elemental mercury and/or the mercury-containing compound in the reaction vessel.

13. The method of claim 11 wherein the first portion of the mercury product solution comprises about 10 vol. % to about 99 vol. % of the mercury product solution in the reaction vessel.

14. The method of claim 11 further comprising:
mixing the first portion of the mercury product solution with an aqueous solution such that the mercury product solution has an acid content of about 30 wt. % or less as measured by AWWA Standard Methods 22nd Edition 2310 B and a specific gravity a point in a range of about 0.95 to about 1.4 as measured as measured according to ASTM Method D1429-13 Test Method C at 20° C.

15. The method of claim 14 wherein the aqueous solution comprises a Group I and/or a Group II hydroxide.

16. The method of claim 14 further comprising:
pumping the first portion of the mercury product solution into a disposal well, wherein the disposal well is classified as a United States Environmental Protection Agency (EPA) Class I Industrial and Municipal Waste Disposal Well.

17. A system comprising:
a source of mercury product solution produced from elemental mercury and/or mercury-containing compounds;
a pump; and
a wellhead;
wherein the source of mercury product solution is fluidically coupled to the pump and the pump is fluidically coupled to the wellhead.

18. The system of claim 17 wherein the wellhead is fluidically coupled to a disposal well classified as a United States Environmental Protection Agency (EPA) Class I Industrial and Municipal Waste Disposal Well.

19. The system of claim 17 wherein the wellhead is fluidically coupled to a disposal well and wherein the pump is configured to pump the mercury product solution into the disposal well.

20. The system of claim 17 wherein the mercury product solution has an acid content of about 30 wt. % or less as measured by AWWA Standard Methods 22nd Edition 2310 B and wherein the mercury product solution has a specific gravity a point in a range of about 0.95 to about 1.4 as measured as measured according to ASTM Method D1429-13 Test Method C at 20° C.
